(19) United States
(12) Patent Application Publication
(10) Pub. No.: US 2013/0290535 A1
(43) Pub. Date: Oct. 31, 2013

(54) APPARATUS AND METHOD FOR MANAGING AN ACCESS CONTROL LIST IN AN INTERNET DEVICE

(71) Applicant: REALTEK SEMICONDUCTOR CORP., HsinChu (TW)

(72) Inventors: Chengwei Du, Suzhou City (CN); Chun-Da Wu, Hsinchu City (TW); Hong-June Hsue, Hsinchu City (TW)

(73) Assignee: Realtek Semiconductor Corp., HsinChu (TW)

(21) Appl. No.: 13/869,978

(22) Filed: Apr. 25, 2013

(30) Foreign Application Priority Data
Apr. 28, 2012 (CN) 201210134121.6

(51) Int. Cl. H04L 12/24

(52) U.S. Cl. CPC H04L 41/04
USPC 709/225

(57) ABSTRACT

An executing apparatus coupled to a main control unit for managing an access control list (ACL) is provided. The executing apparatus is utilized for receiving a specific command transmitted from the main control unit and managing a plurality of rule information of the ACL stored in a storage circuit according to the specific command received.

### BACKGROUND OF THE INVENTION

1. Field of the Invention

The present invention relates to a mechanism for managing/maintaining an access control list (ACL), and more particularly, to an apparatus, executing apparatus and corresponding method for managing the ACL in an internet device.

2. Description of the Prior Art

The access control list (ACL) is an important part of an internet device. An internet device usually employs the ACL to classify the data stream, and processes the packages according to the classes. In addition, the rule information in the ACL is related to each other by respective orders. In other words, the case that a rule information A is arranged before a rule information B and the case that a rule information A is arranged after a rule information B represent that the same data package has different processing results. With the development of internet applications, more accurate processing of the data stream is needed by an internet device, leading to increased amount of rule information in the ACL to be processed by an internet device. Hence, if the management and maintenance of the rule information in the ACL is performed by a main control unit only, the performance of the whole system will degrade severely. Besides, the main control unit has other tasks that include the dealing with the operation of other software. Thus, if the management and maintenance of the ACL is performed by the main control unit only, it will not meet the needs of present internet devices.

### SUMMARY OF THE INVENTION

Therefore, one of the objectives of the present invention is to provide an executing apparatus, apparatus and related method for managing the ACL, to solve the aforementioned problems encountered by the prior art.

An executing apparatus for managing the ACL is disclosed according to an embodiment of the present invention. The executing apparatus is coupled to the main control unit, and the executing apparatus is used for receiving a specific command transmitted from the main control unit, managing the plurality of rule information of the ACL, wherein the ACL is stored in a storage circuit.

A method for managing the ACL is further disclosed according to an embodiment of the present invention. The method includes: transmitting a specific command to an executing apparatus from a main control unit; using the executing apparatus to receive the specific command; using the executing hardware to manage the plurality of rule information of the ACL, wherein the ACL is stored in a storage circuit.

An apparatus for managing the ACL is further disclosed according to an embodiment of the present invention. The apparatus includes a storage circuit, a main control unit and an executing apparatus, the storage circuit is used for storing the ACL, the main control unit is used for transmitting the specific command, and the executing apparatus is coupled to the storage circuit and the main control unit, and managing the ACL stored in the storage circuit, wherein the main control unit transmits the specific command to the executing apparatus, according to the specific command, for using the executing apparatus to manage the ACL stored in the storage circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the apparatus arranged for speeding up the maintenance/management of an ACL in the internet device according to an embodiment of the present invention.

FIG. 2A is a diagram illustrating an embodiment of the executing apparatus shown in FIG. 1 that performs the moving of rule information.

FIG. 2B is a diagram illustrating another embodiment of the executing apparatus shown in FIG. 1 that performs the moving of rule information.

FIG. 2C is a flowchart illustrating the operation of the moving of the rule information performed by the executing apparatus shown in FIG. 1.

FIG. 3A is a diagram illustrating an embodiment of the executing apparatus shown in FIG. 1 that performs the exchanging of rule information.

FIG. 3B is a diagram illustrating an embodiment of the rule information result after exchanging the rule information shown in FIG. 3A.

FIG. 4 is a diagram illustrating the embodiment of the executing apparatus shown in FIG. 1 that moves part of the rule information after deleting part of the rule information.

FIGS. 5A-5B are diagrams illustrating the embodiment of the executing apparatus shown in FIG. 1 that sorts the rule information.

### DETAILED DESCRIPTION

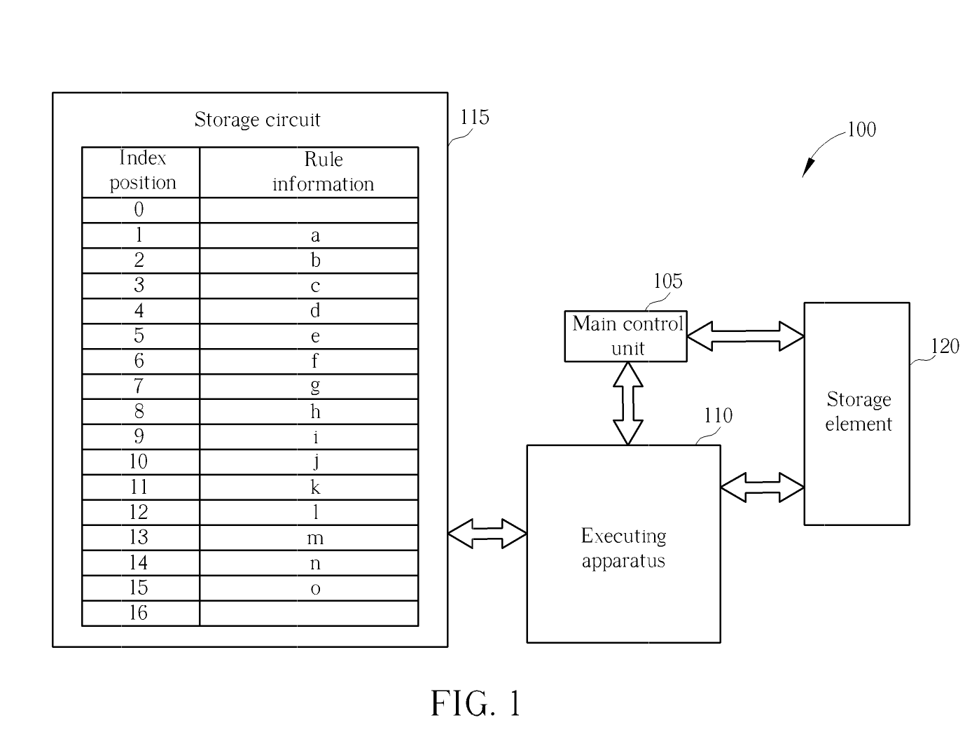

Please refer to FIG. 1, which is a diagram illustrating an apparatus 100 arranged for speeding up the maintenance/management of an access control list (ACL) in the internet device according to an embodiment of the present invention. As shown in FIG. 1, the apparatus 100 includes a main control unit 105, an executing apparatus 110, a storage circuit 115 and a storage element 120. The main control unit 105 may be implemented using a microcontroller unit (MCU); however, this is not a limitation to the present invention. Alternatively, the main control unit 105 may be a microprocessor. The executing apparatus 110 is implemented using hardware. That is, the executing apparatus 110 is executing hardware implemented, for example, by a digital logic circuit. The storage circuit 115 is used to store an ACL. The ACL includes multiple entry positions, each corresponding to an index position and a rule information (also called as criterion information), wherein the index position represents the priority of the corresponding rule information. In an embodiment of the present invention, the index position with a smaller value means higher priority. For example, the priority of the rule information ‘a’ with the entry position 1 is higher than the priority of the rule information ‘b’ with the entry position 2. The rest can be deduced by analogy. Besides, the index position can also represent the storage address of one rule information in the storage circuit 115. In other words, multiple continuous index positions (e.g., index positions 1-3) represent that the corresponding rule information (i.e., rule information ‘a’-'c′) is stored in continuous storage address space, and the two discontinuous groups of index positions represent the discontinuous storage address space. It should be noted that the aforementioned embodiment is only one exemplary implementation of the present invention, and is not meant to be a limitation to the present invention.

Regarding the priority of the rule information, when the data or data stream in the internet device satisfies more than two rule information, it is determined that the data or data stream is processed by the rule information with the highest priority. Besides, each rule information includes multiple fields, such as a criterion field, an action field, an operation field, etc. Therefore, the management of the rule information in the ACL is processed by the executing apparatus 110 in an embodiment of the present invention. Regarding the main control unit 105, only a specific command is needed to be transmitted from the main control unit 105 to the executing apparatus 110 to inform the executing apparatus 110 which command should be executed currently. The main control unit 105 doesn't need to consume the resource to access the information of the ACL in the storage circuit 115, and the operation of accessing the information of the ACL in the storage circuit 115 is accomplished by the executing apparatus 110. Therefore, when the main control unit 105 transmits a specific command to the executing apparatus 110, the executing apparatus 110 analyzes the received specific command, and performs maintenance upon the ACL according to the analyzing result. Because the main control unit 105 doesn't need to access the rule information in the ACL practically, a large amount of the software resource will not be consumed, thus improving the performance of maintaining the ACL largely. It should be noted that the main control unit 105 can also transmit the calculating result to the executing apparatus 110 after performing simple calculations, and the executing apparatus 110 may practically access the information of the ACL in the storage circuit 105 to achieve the management for the ACL. In other words, when the specific command is generated, part of the software calculation can be accomplished by the main control unit 105, and the remaining hardware operation can be accomplished by the executing apparatus 110.

Specifically, the executing apparatus 110 is electrically coupled to the main control unit 105, and used to receive a specific command transmitted from the main control unit 105, analyze the received specific command, and manage a plurality of rule information in the ACL (stored in the storage circuit 115) according to the received specific command. The storage element 120 in an embodiment is implemented using a static random access memory (SRAM), and used to store part of the rule information. However, this is not a limitation to the present invention. In another embodiment, the storage element 120 may be implemented using a different storage element such as a dynamic random access memory (DRAM), a synchronous dynamic random access memory (SDRAM), a double data rate synchronous dynamic random access memory (DDR SDRAM) or an internal register/memory element of the hardware. When the ACL needs to be maintained or managed, the main control unit 105 transmits a command to the executing apparatus 110, and the executing apparatus 110 analyzes the command transmitted from the main control unit 105 to determine the manner used for maintaining the rule information of the ACL, and then performs the action, such as moving, clearing or exchanging, on the rule information automatically. After completing the aforementioned moving, clearing or exchanging action, the executing apparatus 110 may actively inform the main control unit 105 via an interrupt signal. Alternatively, the executing apparatus 110 may configure a status mark (or a status flag) for allowing the main control unit 105 to check the finish of the aforementioned moving, clearing or exchanging action by itself. Because the executing apparatus 110 is fully responsible for maintaining the rule information, the load of the main control unit 105 is lowered, and the performance of the overall system is improved. Besides, the aforementioned specific command includes an adding command, an inserting command, a moving command, a deleting command, an exchanging command, an ordering command or any combination of these commands mentioned above. In the following, each command is described in detail.

When the rule information of the ACL needs to be moved, the main control unit 105 calculates the index positions and the number of the rule information to be moved, where the number of the rule information to be moved can be one or more than one. After calculating the index positions and the number, the main control unit 105 transmits the moving command to the executing apparatus 110, and the moving command indicates the index positions and the number of the rule information to be moved. Specifically, the moving command can indicate an initial index position, a target index position and the number of the rule information to be moved when being implemented. When the executing apparatus 110 receives the moving command, the executing apparatus 110 can calculate an initial index area according to the initial index position and the moving number as indicated by the moving command, and calculate a target index area according to the target index position and the moving number as indicated by the moving command. Therefore, the executing apparatus 110 can move the rule information according to the order of the index positions. Besides, because the main control unit 105 only calculates the initial index position, the target index position and the number of the rule information to be moved, and the remaining calculation is totally completed by the executing apparatus 110, the main control unit 105 can continue to perform other tasks.

Additionally, in another embodiment, the moving command can indicate a source initial position, a source end position and a target initial position, wherein the source initial position and the source end position define the storage sector (for example, the first rule information is stored at the source initial position before being moved, and the last rule information is stored at the source end position before being moved) before the rule information is moved respectively, and the target initial position is the expected storage position of the first rule information after the rule information is moved. The executing apparatus 110 can calculate a target end position by the source initial position, source end position and the target initial position, wherein the target end position is the expected storage position of the last rule information after the rule information is moved. Thus, the executing apparatus 110 can complete the moving of the rule information by moving at least one rule information from the storage space defined by the source initial position and the source end position in the ACL to the storage space defined by the target initial position and the target end position in the ACL, sequentially. Besides, in other embodiments, the moving command can indicate a source initial position, a target initial position and a target end position, wherein the source initial position and the target initial position define the address of the first rule information before the rule information is moved and the address of the first rule information after the rule information is moved, and the target end position is the address of the last rule information after the rule information is moved. The executing apparatus 110 can calculate a source end position by the source initial position, target initial position and target end position, wherein the source end position is the storage position of the last rule information before the rule information is moved. Thus, the executing apparatus 110 can complete the moving of the rule information by moving at least one rule information from the storage space defined by the source initial position and the source end position in the ACL to the storage space defined by the target initial position and the target end position in the ACL, sequentially. Accordingly, any combination of the moving parameters (e.g., the source initial position, the target initial position, the number of the rule information to be moved, the source end position, the target end position and etc.) used in generating a moving command to move the rule information value(s) from an initial index area to a target index area accurately should be regarded as being within the scope of this invention.

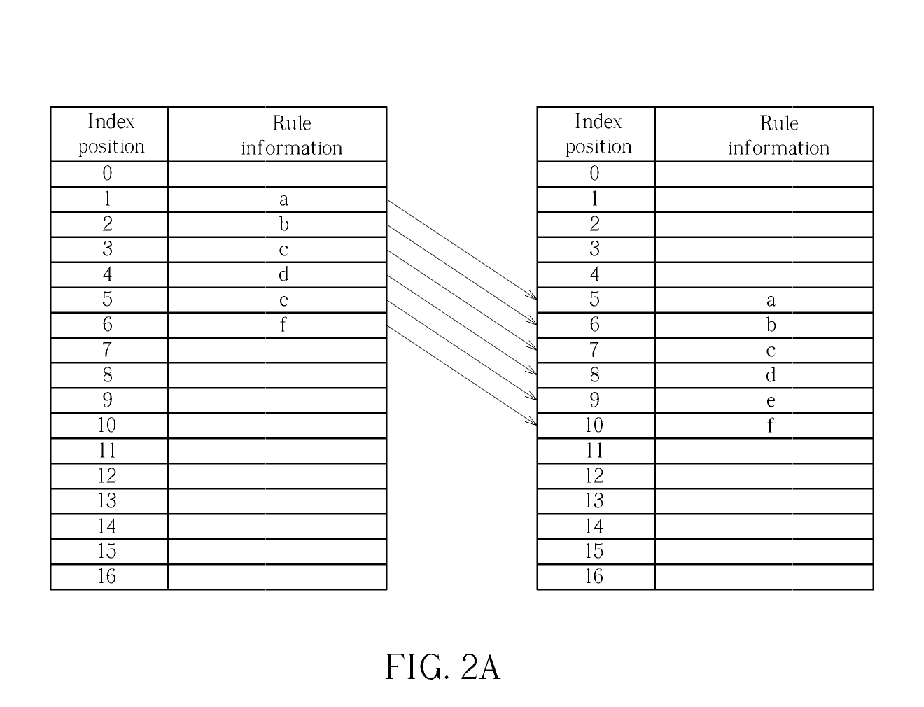

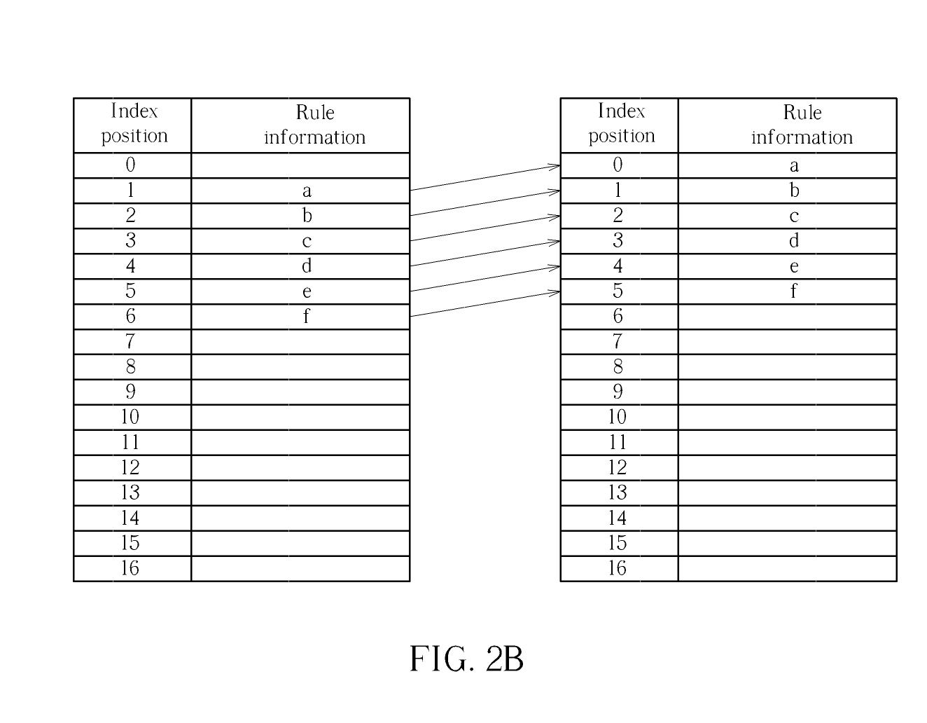

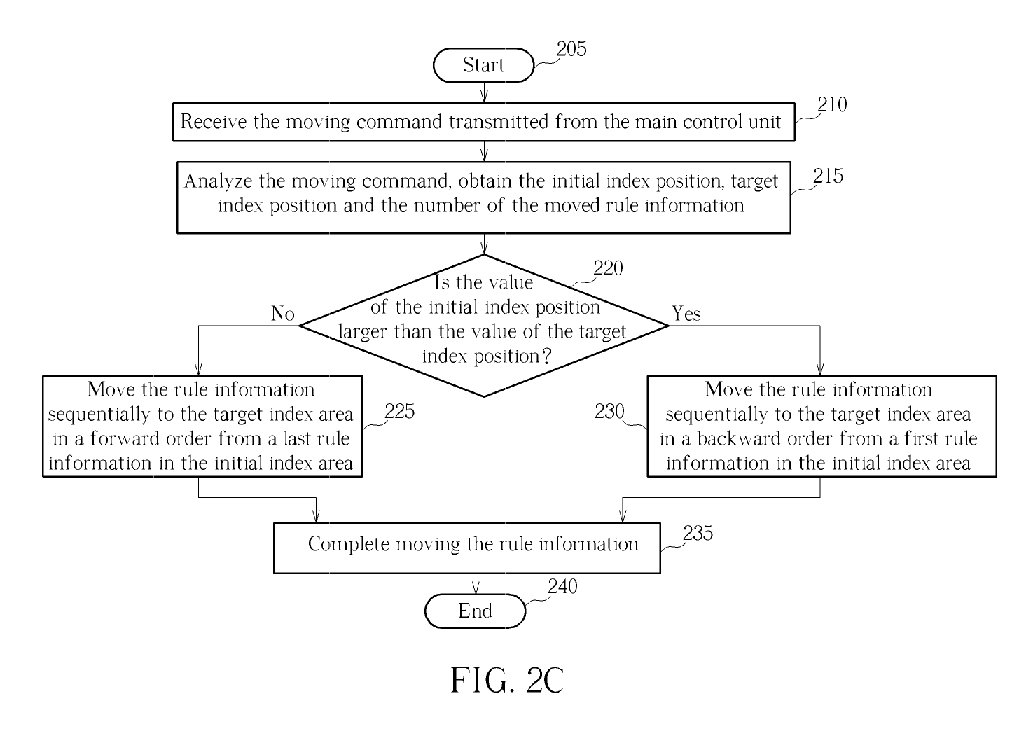

Please refer to FIG. 2A, which is a diagram illustrating an embodiment of the executing apparatus 110 shown in FIG. 1 that performs the moving of rule information. As shown in FIG. 2A, the ACL stored in the storage circuit 115 currently includes six rule information ‘a’ to ‘f’ stored in the index position 1 to index position 6, respectively. The main control unit 105 transmits a moving command to the executing apparatus 110, wherein the moving command indicates that the initial index position is the index position 1, the target index position is the index position 5 and the number of the rule information to be moved is 6. The executing apparatus 110 can determine that the moving of the rule information is moving the rule information of the initial index area formed by index position 1-index position 6 to the target index area formed by index position 5-index position 10 according to the information of the moving command. To prevent the value of the rule information from being overwritten before moved, if the value of the target index position (for example, the index position 5) is larger than the value of the initial index position (for example, the index position 1), the executing apparatus 110 moves the rule information sequentially from the last rule information in the initial index area to the target initial index area in an order from back to front (i.e., a backward order starting from a last index position of the initial index area to a first index position of the initial index area). For example, the executing apparatus 110 moves the rule information ‘f’ (the last rule information) corresponding to the index position 6 to the storage space of the index position 10, the rule information ‘e’ corresponding to the index position 5 to the storage space of the index position 9, the rule information ‘d’ corresponding to the index position 4 to the storage space of the index position 8, and so on. In the end, the rule information ‘a’ corresponding to the index position 1 is moved to the storage space of the index position 5, and the moving of rule information is completed accordingly.

On the other hand, if the value of a target index position is smaller than the value of an initial index position, the executing apparatus 110 moves the rule information sequentially from the first rule information in the initial index area to the target initial index area in an order from front to back (i.e., a forward order starting from a first index position of the initial index area to a last index position of the initial index area). Please refer to FIG. 2B, which is a diagram illustrating another embodiment of the executing apparatus 110 shown in FIG. 1 that performs the moving of rule information. As shown in FIG. 2B, the ACL stored in the storage circuit 115 currently includes six rule information ‘a’ to ‘f’ stored in the index position 1 to index position 6, respectively. The main control unit 105 transmits a moving command to the executing apparatus 110, wherein the moving command indicates that the initial index position is the index position 1, the target index position is the index position 0 and the number of the rule information to be moved is 6. The executing apparatus 110 can determine that the moving of the rule information is moving the rule information of the initial index area formed by index position 1-index position 6 to the target index area formed by index position 5-index position 10 according to the information of the moving command. To prevent the value of the rule information from being overwritten before moved, if the value of the target index position (for example, the index position 0) is smaller than the value of the initial index position (for example, the index position 1), the executing apparatus 110 moves the rule information ‘a’ (the first rule information) corresponding to the index position 1 to the storage space of the index position 0, the rule information ‘b’ corresponding to the index position 2 to the storage space of the index position 1, the rule information ‘c’ corresponding the index position 3 to the storage space of the index position 2, and so on. In the end, the rule information ‘d’ corresponding to the index position 6 is moved to the storage space of the index position 5, and the moving of rule information is completed accordingly. To put it another way, moving the rule information from the first rule information in the initial index area to the target index area in an order from front to back is performed.

Additionally, the executing apparatus 110 may be configured to perform an intelligent moving operation of the rule information. The executing apparatus 110 analyzes the content of the current rule information existing in the ACL to obtain an analyzing result, and moves the rule information according to the analyzing result to make the rule information with similar contents to be located nearby after being moved, which facilitates following read/write operations performed by the executing apparatus 110. For example, the content of the rule information can include a criterion field, an action field, an operating field, etc. The executing apparatus 110 can analyze different fields or only one field to obtain the analyzing result, and then move the rule information according to the analyzing result. Additionally, to make the reader have better understanding of the aforementioned moving operation of the rule information in the embodiment of the present invention, FIG. 2C shows a flowchart illustrating the operation of the moving of the rule information performed by the executing apparatus 110 shown in FIG. 1. If the same result is achieved substantially, then it is not necessary to obey the order of the steps in the flowchart shown in FIG. 2C, and the steps shown in FIG. 2C are not necessary to be performed continuously, that is, other steps can also be inserted. Please refer to the description of the steps in FIG. 2C and the description of the aforementioned moving operation of the rule information together for the detailed description of the steps in the procedure. Further description is omitted here for brevity.

When one or more than one rule information is needed to be added or inserted to the ACL, the main control unit 105 transmits the adding command or inserting command to the executing apparatus 110. The executing apparatus 110 determines the index position to be added or inserted with the rule information by analyzing the adding command or the inserting command. In other words, the main control unit 105 only needs to inform the necessary message (for example, the storage address of the added or inserted rule information), and the executing apparatus 110 analyzes and determines the corresponding added index position or the corresponding inserted index position. Hence, part of the calculation/computation function of the main control unit 105 is handed over to the hardware processing logic of the executing apparatus 110. For example, referring to FIG. 1 again, when one rule information is added to the ACL, the main control unit 105 transmits an adding command to the executing apparatus 110 to inform that the rule information is stored in a storage space of a storage element 120 (the storage element 120 may be a static random access memory or a buffer). Therefore, the executing apparatus 110 can read the rule information from the storage space of the storage element 120 according to the adding command, and then add the rule information to the ACL in the storage circuit 115. For example, the executing apparatus 110 adds the rule information to the storage space of a certain blank index position (with no data written therein yet) in the ACL, like the storage space of the index position 0 or the index position 16. In other words, in this embodiment, when the rule information is added, the rule information is added to the storage space of an index position preceding to index positions of the current rule information or the storage space of an index position following index positions of the current rule information, to make all of the rule information stored in the continuous storage space. However, this is merely an embodiment, and is not a limitation to the present invention.

Additionally, when one rule information is needed to be inserted to the ACL, the main control unit 105 transmits an inserting command to the executing apparatus 110 to inform that the rule information is stored in a storage space of the storage element 120 (the storage element 120 may be a static random access memory or a buffer). Therefore, the executing apparatus 110 can read the rule information from the storage space of the storage element 120 according to the inserting command, and then insert the rule information to ACL of the storage circuit 115. At the same time, the executing apparatus 110 analyzes the importance of the rule information in the current ACL and the importance of the read rule information, or analyzes the correlated message of the rule information to determine the proper index position to which the rule information to be inserted is written; and after determining the index position to be inserted, the executing apparatus 110 moves the corresponding rule information automatically to thereby leave the index position to the rule information to be inserted. Next, the executing apparatus 110 writes the rule information to the index position to complete the command of inserting the rule information, and then reports the result to the main control unit 105. It should be noted that, because the moving operation of the rule information performed by the executing apparatus 110 has been described above, further description is omitted here for brevity. Besides, the aforementioned operation of adding or inserting the rule information can be used to add or insert a plurality of rule information to the ACL.

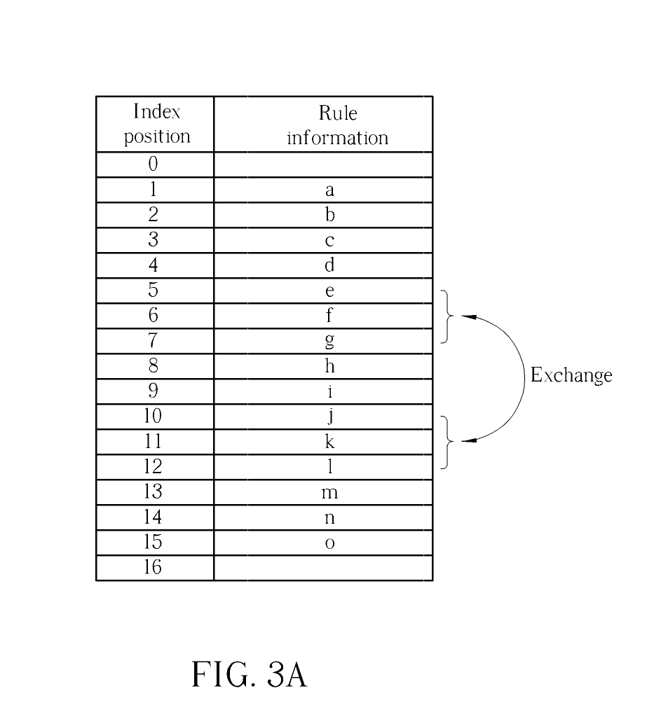

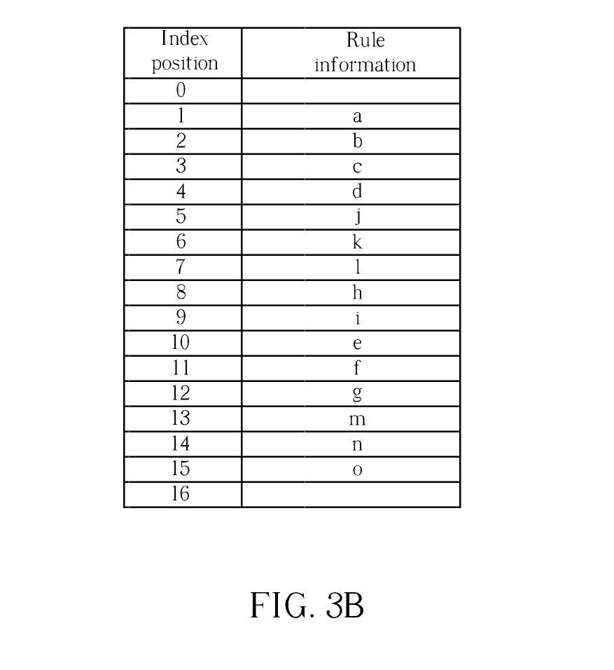

Additionally, when the rule information of the ACL is needed to be exchanged, the main control unit 105 transmits an exchanging command to the executing apparatus 110. The exchanging command indicates the first index position and the second index position, and the executing apparatus 110 can exchange the corresponding rule information according to the index positions indicated by the exchanging command, that is, exchange the rule information orderly. Besides, the exchanging command can also indicate that one rule information should be exchanged with another rule information, and the executing apparatus 110 refers to the exchanging command to analyze the rule information in the current ACL for finding the index positions of the rule information to be exchanged and then exchanging the rule information according to the index positions. Please refer to FIG. 3A, which is a diagram illustrating an embodiment of the executing apparatus shown in FIG. 1 that performs the exchanging of rule information. As sown in FIG. 3A, the executing apparatus 110 exchanges rule information ‘e’-rule information ‘g’ of index position 5-index position 7 with rule information ‘j’-rule information ‘I’ of index position 10-index position 12, sequentially. The stored rule information of the ACL after the exchanging operation can be seen in FIG. 3B.

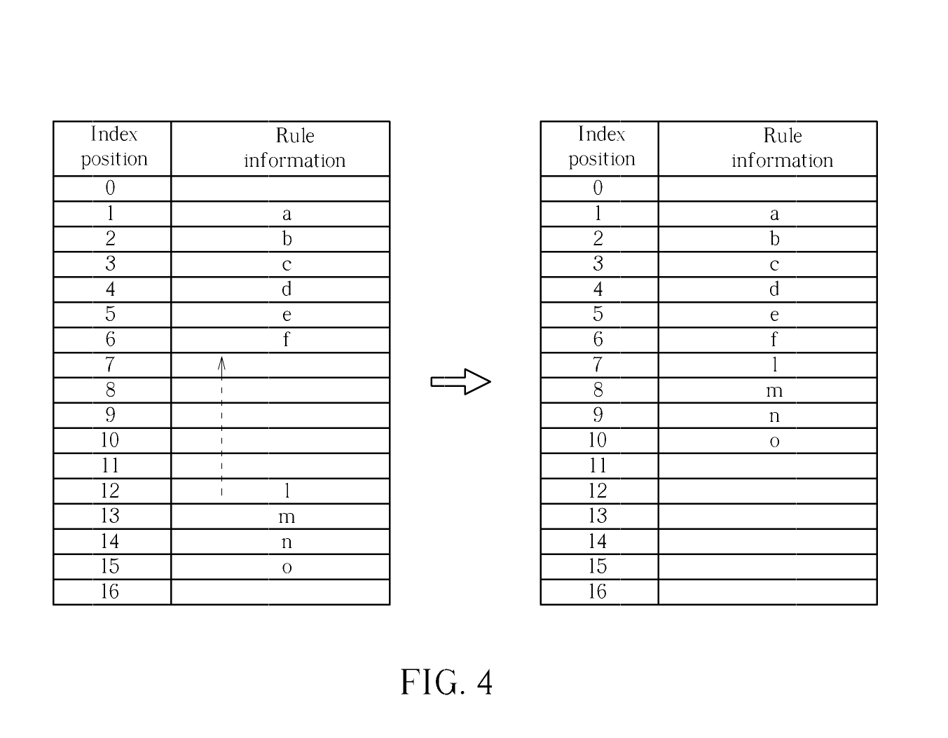

Additionally, when the rule information of the ACL is needed to be deleted (or cleared), the main control unit 105 transmits a deleting command to the executing apparatus 110. The deleting command indicates an index position to be cleared or multiple index positions to be cleared. For example, the deleting command can indicate the initial index position and the end index position to be cleared, or the deleting command can indicate the initial index position to be cleared and the number of rule information to be cleared. The executing apparatus 110 therefore can delete or clear the corresponding rule information orderly according to the aforementioned information indicated by the deleting command. Besides, the deleting command can also indicate that one rule information or multiple rule information satisfying a specific criterion needs to be cleared, and the executing apparatus 110 analyzes the rule information in the current ACL, finds the index positions of the rule information to be deleted, and then deletes or clears the rule information according to the index positions. Further, after deleting the rule information, the executing apparatus 110 can also move one or more rule information forward to full in the free storage space released due to the deleted rule information. As shown in FIG. 4, after deleting or clearing the content of the rule information corresponding to index position 7-index position 11, the executing apparatus 110 moves rule information T-rule information ‘o’ corresponding to index position 12-index position 15 to the storage space corresponding to index position 7-index position 10 sequentially and respectively, thereby filling in the free storage space to make the index positions continuous. Because the operation of moving the rule information has been described above, further description is omitted here for brevity. It should be noted that, deleting/clearing one rule information of an index position may be achieved through nullifying the content of the rule information or resetting the corresponding content by default values to represent that the content has been cleared.

Besides, when the rule information of the ACL is needed to be sorted, the main control unit 105 transmits a sorting command to the executing apparatus 110. The executing apparatus 110 sorts the rule information in the ACL according to the sorting command. The sorting command can indicate the content of the rule information (e.g., one specific field or multiple specific fields). For example, one rule information can include a criterion field, an action field, an operation field, etc. The sorting command can indicate that sorting is performed in accordance with a certain field. For example, if the sorting command indicates the sorting is performed in accordance with the content of the criterion field, then the apparatus 110 analyzes the content of the criterion fields of different rule information in the ACL according to the sorting command, classifies the criterion contents of different types, gives different priorities according to the criterion contents of different types, and then arranges the criterion contents corresponding to the same type in continuous index positions. Besides, the executing apparatus 110 may sort the rule information according to the content of a different field such as the action field or the operation field.

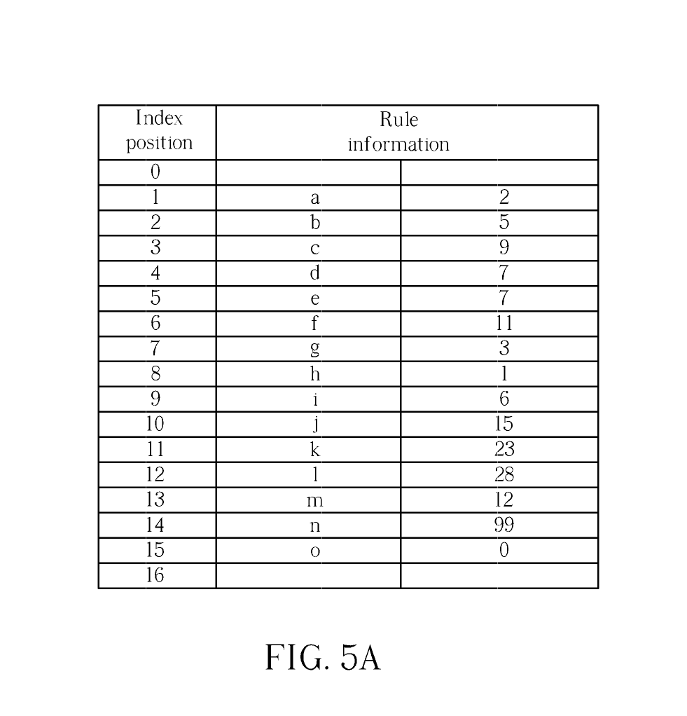

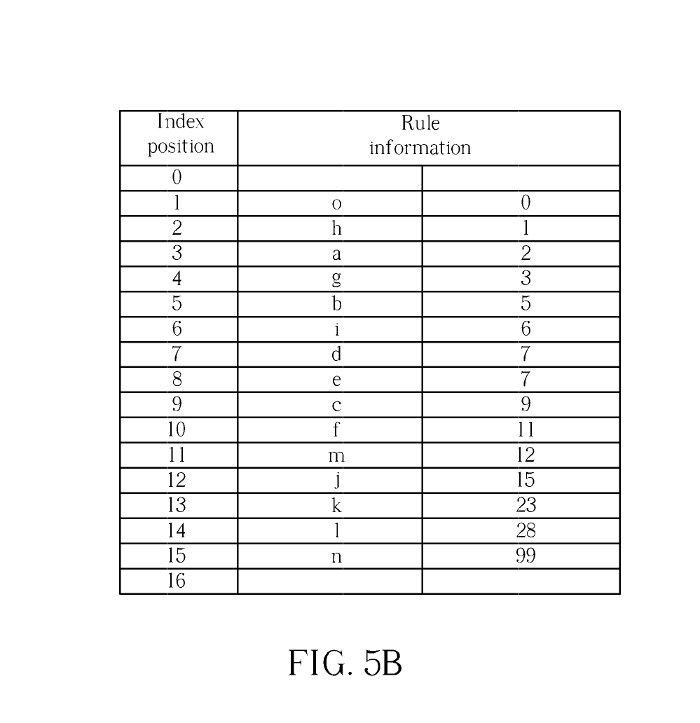

Additionally, the sorting command may indicate that the sorting of the rule information is performed in accordance with a certain specific value. For example, please refer to FIG. 5A and FIG. 5B. FIG. 5A is a diagram illustrating the rule information before sorting, and FIG. 5B is a diagram illustrating the rule information after sorting. As shown in FIG. 5A, before the rule information is sorted, the rule information ‘a’ to ‘b’ sequentially stored in the ACL correspond to specific values (e.g., weighting values) respectively, as shown in FIG. 5A. The sorting command indicates that the sorting is performed in accordance with the weighting values. In this embodiment, a smaller weighting value means larger weighting. Therefore, the executing apparatus 110 analyzes weighting values corresponding to a plurality of rule information, and then sorts the rule information according to the analyzing result. As the operation of moving the rule information which is used during the sorting is described above, further description is omitted here for brevity. The sorting result is shown in FIG. 5B.

In summary, the command/instruction issued by the main control unit to manage the ACL is executed by an executing apparatus implemented by a hardware processing logic according to an embodiment of the present invention, which allows the resource of the main control unit to be employed to perform other computations without being spent upon managing the rule information of the ACL. In this way, the processing speed and performance of the internet device is effectively improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An internet device, comprising:
a main control unit of the internet device;
an executing apparatus, coupled to the main control unit to receive a specific command transmitted from the main control unit;
a storage circuit, to store a plurality of rule information of an access control list (ACL);
wherein the executing apparatus manages the plurality of rule information of the ACL according to the specific command received.

2. The internet device of claim 1, wherein the specific command is an adding command, and the executing apparatus is arranged for referring to the adding command to write a first rule information into a first index position in the ACL stored in the storage circuit.

3. The internet device of claim 2, wherein the adding command is an inserting command, and the executing apparatus is arranged for referring to the inserting command to insert the first rule information in the first index position between a plurality of index positions of the ACL.

4. The internet device of claim 3, wherein the executing apparatus moves a second rule information originally stored at the first index position to a second index position, and then writes the first rule information to the first index position, where a priority of the second index position is lower than a priority of the first index position.

5. The Internet device of claim 2, wherein the first rule information is pre-stored in a storage element, the adding command indicates an address at which the first rule information is stored in the storage element, and the executing apparatus obtains the first rule information according to the address indicated by the adding command, analyzes a plurality of current rule information of the ACL to generate an analyzing result, and writes the first rule information to the first index position of the ACL.

6. The Internet device of claim 1, wherein the specific command is a moving command, and the executing apparatus is arranged for referring to the moving command to move a rule information from a first index position to a second index position in the ACL, where the rule information is originally stored at the first index position of the ACL before moved.

7. The Internet device of claim 6, wherein the moving command indicates an initial index position and a target index position, or the moving command indicates a source initial position and a target initial position; and the executing apparatus is arranged for referring to the initial index position and the target index position or the source initial position and the target initial position to sequentially move at least a rule information from the initial index position or the source initial position in the ACL to the target index position or the target initial position in the ACL.

8. The Internet device of claim 7, wherein:
when the moving command indicates the initial index position and the target index position, the moving command further indicates a number of rule information to be moved, and the executing apparatus moves the rule information according to the initial index position, the target index position and the number of rule information to be moved; and
when the moving command indicates the source initial position and the target initial position, the moving command further indicates a source end position or a target end position, and the executing apparatus moves the rule information according to the source initial position, the source end position and the target initial position, or according to the source initial position, the source end position and the target end position.

9. The internet device of claim 7, wherein the initial index position is located before the target index position, the moving command further indicates a number of rule information to be moved, the number of rule information to be moved and the initial index position determine an initial index area, the number of rule information to be moved and the target index position determine a target index area, and the executing apparatus sequentially moves a plurality of rule information in the initial index area to a plurality of corresponding index positions in the target index area in a backward order starting from a last index position of the initial index area to a first index position of the initial index area.

10. The internet device of claim 7, wherein the initial index position is located after the target index position, the moving command further indicates a number of rule information to be moved, the number of rule information to be moved and the initial index position determine an initial index area, the number of rule information to be moved and the target index position determine an initial index area, the number of rule information to be moved and the target index position determine a target index area, and the executing apparatus sequentially moves a plurality of rule information in the initial index area to a plurality of corresponding index positions in the target index area in a forward order starting from a first index position of the initial index area to a last index position of the initial index area.

11. The internet device of claim 6, wherein the moving command indicates a combination of three moving parameters selected among a source initial position, a target initial position, a number of the rule information to be moved, a source end position, and a target end position.

12. The internet device of claim 1, wherein the specific command is a deleting command and arranged for indicating at least one rule information satisfying a specific criterion, the executing apparatus is arranged for referring to the deleting command to delete the at least one rule information to which at least a first index position in the ACL of the storage circuit corresponds.

13. The internet device of claim 1, wherein the specific command is an exchanging command; and the executing apparatus is arranged for referring to the exchanging command to exchange at least a first rule information to which at least a first index position in the ACL of the storage circuit corresponds with at least a second rule information to which at least a second index position in the ACL of the storage circuit corresponds, where the first rule information is moved from the first index position to the second index position, and the second rule information is moved from the second index position to the first index position.

14. The internet device of claim 1, wherein the specific command is a sorting command; and the executing apparatus is arranged for referring to the sorting command to analyze the plurality of rule information at a plurality of index positions in the ACL of the storage circuit and accordingly generate an analyzing result, and sorting the plurality of rule information according to the analyzing result.

15. The internet device of claim 14, wherein the plurality of index positions are a plurality of discontinuous index positions, and the executing apparatus is arranged for sorting the plurality of discontinuous index positions to generate a plurality of continuous index positions.

16. A method arranged for managing an access control list (ACL), comprising:
transmitting a specific command from a main control unit to an executing apparatus;
utilizing the executing apparatus to receive the specific command;
utilizing the executing hardware to manage a plurality of rule information of the ACL stored in a storage circuit according to the specific command.

17. The method of claim 16, wherein the specific command is an adding command, and the step of managing the plurality of rule information of the ACL comprises:
writing a first rule information into a first index position in the ACL according to the adding command.

18. The method of claim 17, wherein the adding command is an inserting command, and the step of writing the first rule information into the first index position in the ACL comprises:
inserting the first rule information at the first index position between a plurality of index positions of the ACL according to the inserting command.

19. The method of claim 17, wherein the step of inserting the first rule information at the first index position between the plurality of index positions of the ACL comprises:
moving a second rule information originally stored in the first index position to a second index position; and
writing the first rule information to the first index position, where a priority of the second index position is lower than a priority of the first index position.

20. The method of claim 17, wherein the first rule information is pre-stored in a storage element, the adding command indicates an address at which the first rule information is stored in the storage element, and the step of writing the first rule information to the first index position in the ACL comprises:
obtaining the first rule information according to the address indicated by the adding command;
analyzing a plurality of current rule information of the ACL to generate an analyzing result; and
writing the first rule information to the first index position of the ACL according to the analyzing result.

21. The method of claim 16, wherein the specific command is a moving command, and the step of managing the plurality of rule information of the ACL comprises:
moving a rule information from a first index position to a second index position in the ACL according to the moving command, where the rule information is originally stored at the first index position of the ACL before moved.

22. The method of claim 21, wherein the moving command indicates an initial index position and a target index position, or the moving command indicates a source initial position and a target initial position; and the step of moving the rule information from the first index position to the second index position in the ACL comprises:
sequentially moving at least a rule information from the initial index position or the source initial position in the ACL to the target index position or the target initial position in the ACL, according to the initial index position and the target index position or the source initial position and the target initial position.

23. The method of claim 21, wherein:
when the moving command indicates the initial index position and the target index position, the moving command further indicates a number of rule information to be moved, and the step of sequentially moving at least the rule information from the initial index position in the ACL to the target index position in the ACL moves the rule information by further referring to the number of rule information to be moved; and
when the moving command indicates the source initial position and the target initial position, the moving command further indicates a source end position or a target end position, and the step of sequentially moving at least the rule information from the initial index position in the ACL to the target index position in the ACL moves the rule information by further referring to the source end position or the target end position.

24. The method of claim 22, wherein the initial index position is located before the target index position, the moving command further indicates a number of rule information to be moved, and the step of moving the at least one rule information to the target index position in the ACL comprises:
determining an initial index area according to the number of rule information to be moved and the initial index position;
determining a target index area according to the number of rule information to be moved and the target index position; and
sequentially moving a plurality of rule information in the initial index area to a plurality of corresponding index positions in the target index area in a forward order starting from a last index position of the initial index area to a first index position of the initial index area.

25. The method of claim 22, wherein the initial index position is located after the target index position, the moving command further indicates a number of rule information to be moved, and the step of moving the at least one rule information to the target index position in the ACL comprises:
determining an initial index area according to the number of rule information to be moved and the initial index position;
determining a target index area according to the number of rule information to be moved and the target index position; and
sequentially moving a plurality of rule information in the initial index area to a plurality of corresponding index positions in the target index area in a backward order starting from a first index position of the initial index area to a last index position of the initial index area.

26. The method of claim 21, wherein the moving command indicates a combination of three moving parameters selected among a source initial position, a target initial position, a number of the rule information to be moved, a source end position, and a target end position.

27. The method of claim 16, wherein the specific command is a deleting command and arranged for indicating at least one rule information satisfying a specific criterion, and the step of managing the plurality of rule information of the ACL comprises:
according to the deleting command, deleting the at least one rule information to which at least one corresponding index position in the ACL of the storage circuit corresponds.

28. The method of claim 16, wherein the specific command is an exchanging command, and the step of managing the plurality of rule information of the ACL comprises:
according to the exchanging command, exchanging at least a first rule information to which at least a first index position in the ACL of the storage circuit with at least a second rule information to which at least a second index position in the ACL of the storage circuit, where the first rule information is moved from the first index position to the second index position, and the second rule information is moved from the second index position to the first index position.

29. The method of claim 16, wherein the specific command is a sorting command, and the step of managing the plurality of rule information of the ACL comprises:
sorting the plurality of rule information at a plurality of index positions in the ACL of the storage circuit according to the sorting command.

30. The method of claim 29, wherein the plurality of index positions are a plurality of discontinuous index positions, and the step of sorting the plurality of rule information in the plurality of index positions in the ACL of the storage circuit comprises:
sorting the plurality of discontinuous index positions to generate a plurality of continuous index positions.
